(19) United States
(12) Patent Application Publication
(10) Pub. No.: US 2006/0053295 A1
(43) Pub. Date: Mar. 9, 2006

(54) Methods and systems for content detection in a reconfigurable hardware

(76) Inventors: Bharath Madhusudan, Redwood City, CA (US); John W. Lockwood, St. Louis, MO (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/210,639

(22) Filed: Aug. 24, 2005

Related U.S. Application Data
(60) Provisional application No. 60/604,372, filed on Aug. 24, 2004.

(51) Int. Cl. H04L 9/30; H04L 9/00; H04K 1/00; G06F 12/14; H04L 9/32; G06F 11/00; G06F 11/30; G06F 11/22; G06F 11/32; G06F 11/34; G06F 11/36; G06F 12/16; G06F 15/18; G08B 23/00

(52) U.S. Cl. 713/181; 380/30; 713/188; 726/24

(57) ABSTRACT

Methods and systems consistent with the present invention identify a repeating content in a data stream. A hash function is computed for at least one portion of a plurality of portions of the data stream. The at least one portion of the data stream has benign characters removed therefrom to prevent the identification of a benign string as the repeating content. At least one counter of a plurality of counters is incremented responsive to the computed hash function result. Each counter corresponds to a respective computed hash function result. The repeating content is identified when the at least one of the plurality of counters exceeds a count value. It is verified that the identified repeating content is not a benign string.

### CROSS-REFERENCE TO RELATED APPLICATIONS

This Application claims the benefit of the filing date and priority to the following patent application, which is incorporated herein by reference to the extent permitted by law:

U.S. Provisional Application Ser. No. 60/604,372, entitled “METHODS AND SYSTEMS FOR CONTENT DETECTION IN A RECONFIGURABLE HARDWARE”, filed Aug. 24, 2004.

### BACKGROUND OF THE INVENTION

The present invention generally relates to the field of network communications and, more particularly, to methods and systems for detecting content in data transferred over a network.

Internet worms work by exploiting vulnerabilities in operating systems and other software that run on systems. The attacks compromise security and degrade network performance. Their impact includes large economic losses for businesses resulting from system down-time and loss of worker productivity. Systems that secure networks against malicious code are expected to be a part of critical Internet infrastructure in the future. These systems, which are referred to as Intrusion Detection and Prevention Systems (IDPS), currently have limited use because they typically filter only previously identified worms.

### SUMMARY OF THE INVENTION

Methods and systems consistent with the present invention detect frequently occurring content, such as worm signatures, in network traffic. The content detection is implemented in hardware, which provides for higher throughput compared to conventional software-based approaches. Data transmitted over a data stream in a network is scanned to identify patterns of similar content. Frequently occurring patterns of data are identified and reported as likely worm signatures or other types of signatures. The data can be scanned in parallel to provide high throughput. Throughput is maintained by hashing several windows of bytes of data in parallel to on-chip block memories, each of which can be updated in parallel. The identified content can be compared to known signatures stored in off-chip memory to determine whether there is a false positive. Since methods and systems compared to known signatures stored in off-chip memory to determine whether there is a false positive. Since methods and systems consistent with the present invention identify frequently occurring patterns, they are not limited to identifying known signatures.

In accordance with methods consistent with the present invention, a method in a data processing system for identifying a repeating content in a data stream is provided. The method comprising the steps of: computing a hash function for at least one portion of a plurality of portions of the data stream; incrementing at least one counter of a plurality of counters responsive to the computed hash function result, each counter corresponding to a respective computed hash function result; identifying the repeating content when the at least one of the plurality of counters exceeds a threshold value; and verifying that the identified repeating content is not a benign string.

In accordance with systems consistent with the present invention, a system for identifying a repeating content in a data stream is provided. The system comprises: a hash function computation circuit that computes a hash function for at least one portion of a plurality of portions of the data stream; a plurality of counters, at least one counter of a plurality of counters being incremented responsive to the computed hash function result, each counter corresponding to a respective computed hash function result; a repeating content identifier that identifies the repeating content when the at least one of the plurality of counters exceeds a count value; and a verifier that verifies that the identified repeating content is not a benign string.

In accordance with systems consistent with the present invention, a system for identifying a repeating content in a data stream is provided. The system comprises: means for computing a hash function for at least one portion of a plurality of portions of the data stream; means for incrementing at least one counter of a plurality of counters responsive to the computed hash function result, each counter corresponding to a respective computed hash function result; means for identifying the repeating content when the at least one of the plurality of counters exceeds a count value; and means for verifying that the identified repeating content is not a benign string.

Other features of the invention will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

The accompanying drawings, which are incorporated in and constitute a part of this specification, illustrate an implementation of the invention and, together with the description, serve to explain the advantages and principles of the invention. In the drawings, FIG. 1A is a block diagram of a system that performs content detection consistent with the present invention;

FIG. 1B is a functional block diagram that shows how a signature detection device processes a data stream consistent with the present invention;

FIG. 2 is a block diagram of the signature detection device consistent with the present invention;

FIG. 3 is a block diagram of a count processor consistent with the present invention;

FIG. 4 is a block diagram of a character filter consistent with the present invention;

FIG. 5 is a block diagram of a byte shifter consistent with the present invention;

FIG. 6 is a block diagram of a control packet containing a benign string consistent with the present invention;

FIG. 7 is a block diagram of a large count vector consistent with the present invention;

FIG. 8 is a block diagram of the large count vector of FIG. 7 in more detail;

FIG. 9 is a block diagram a pipeline consistent with the present invention;

FIG. 10 is a functional block diagram depicting the parallel processing of bytes of the data stream;

FIG. 11 shows an example of how the priority encoder handles data without collisions;

FIG. 12 shows an example of how the priority encoder handles data with collisions;

FIG. 13 is a block diagram of an analyzer consistent with the present invention;

FIG. 14 is a state diagram of the analyzer states consistent with the present invention; and

FIG. 15 is a block diagram of a control packet issued from an alert generator consistent with the present invention.

Corresponding reference characters indicate corresponding parts throughout the several views of the drawings.

### DETAILED DESCRIPTION OF THE INVENTION

Reference will now be made in detail to an implementation in accordance with methods, systems, and articles of manufacture consistent with the present invention as illustrated in the accompanying drawings.

Methods and systems consistent with the present invention detect frequently appearing content, such as worm signatures, in a data stream, while being resistant to polymorphic techniques, such as those employed by worm authors. To effect content detection at a high speed, the system is implemented in hardware.

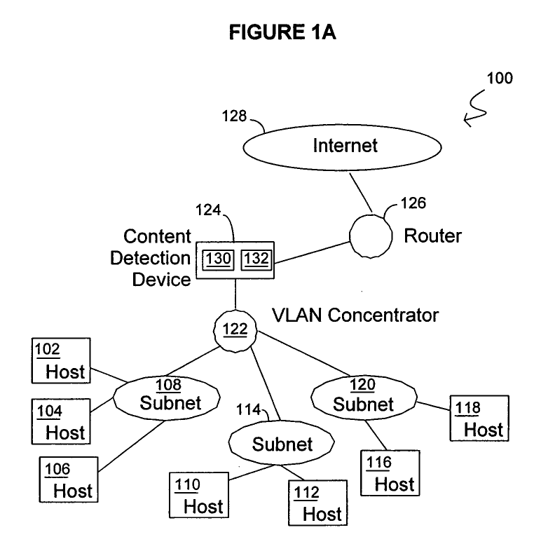

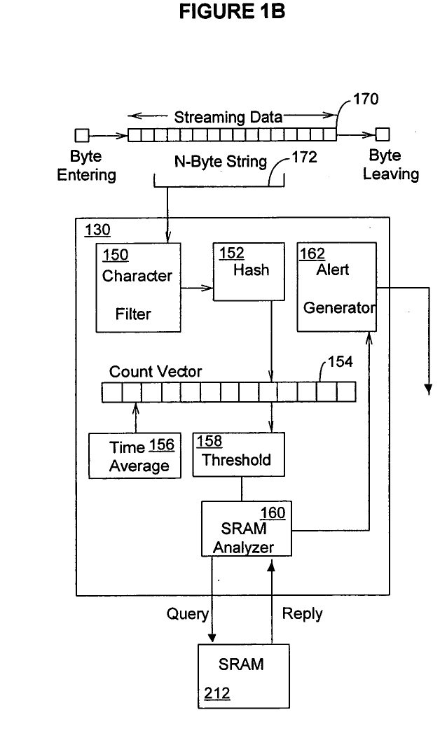

FIG. 1A is a block diagram of an illustrative data processing system 100 suitable for use with methods and systems consistent with the present invention. As shown, a plurality of hosts are connected to a plurality of sub-networks. Namely, hosts 102, 104 and 106 are connected to sub-network 108; hosts 110 and 112 are connected to sub-network 114; and hosts 116 and 118 are connected to sub-network 120. Traffic between the respective sub-networks and between the sub-networks and a larger network 128, such as the Internet, passes through a router 126. A virtual local area network (VLAN) concentrator 122 concentrates network traffic entering router 126. By placing a signature detection device 124 between the router and VLAN concentrator 122, traffic between the sub-networks can be scanned for content.

In the illustrative example of FIG. 1A, signature detection device 124 is a field-programmable port extender (FPX) platform. The FPX platform allows the processing of high speed network flows by using a large field programmable gate array (FPGA) 130, such as the Xilinx XCV2000E FPGA. The signature detection circuits described below can be downloaded into FPGA 130 to process the network flows at traffic rates of up to 2.5 Gigabits per second. Network traffic is clocked into FPGA 130 using a 32-bit-wide data word. One having skill in the art will appreciate that methods and systems consistent with the present invention can be implemented using hardware and software components different than those described herein. For example, the signature detection device can be implemented in a device other than an FPX platform.

In the illustrative examples described herein, reference is made to detecting worm signatures, however, methods and systems consistent with the present invention are not limited thereto. Methods and systems consistent with the present invention identify repeating content in a data stream. The repeating content can be, but is not limited to, worms; viruses; the occurrence of events when large numbers of people visit a website; the presence of large amounts of similar email sent to multiple recipients, such as spam; the repeated exchange of content, such as music or video, over a peer-to-peer network; and other types of repeating content.

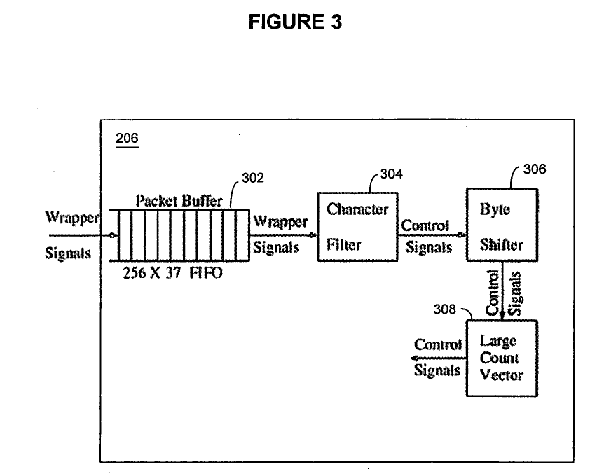

FIG. 1B is a functional block diagram that shows how signature detection device 124 processes a data stream consistent with the present invention. In the illustrative example, field programmable gate array 130 includes functional components for a character filter 150, a hash processor 152, a count vector 154, a time average processor 156, a threshold analyzer 158, an off-chip memory analyzer 160, and an alert generator 162. These functional components provide an illustrative, high-level functional view of the field programmable gate array 130. Field programmable gate array 130 and its functionality is described in more detail below with reference to FIGS. 3-15.

As shown in the illustrative example, character filter 150 samples data from a data stream 170 and filters out characters that are unlikely to be part of binary data to provide an N-byte data string 172. As will be described in more detail below, worms typically consist of binary data. Thus, character filter 150 filters out some characters that are unlikely to characterize a worm signature. Hash processor 152 calculates a k-bit hash over the N-byte string 172, and hashes the resulting signature to count vector 154. As will be described in more detail below, count vector 154 can comprise a plurality of count vectors. When a signature hashes to count vector 154, a counter specified by the hash is incremented. At periodic intervals, called measurement intervals herein, the counts in each of the count vectors are decremented by an amount equal to or greater than the average number of arrivals due to normal traffic, as determined by time average processor 156. When count vector 154 reaches a predetermined threshold, as determined by threshold analyzer 158, off-chip memory analyzer 160 hashes the offending string to a table in off-chip memory 212. The next time the same string occurs, a hash is made to the same location in off-chip memory 212 to compare the two strings. If the two strings are the same, an alert is generated. If the two strings are different, the string in off-chip memory 212 is overwritten with the new string. Therefore, off-chip memory analyzer 160 can reduce the number of alerts by reducing alerts due to semi-frequently occurring strings. On receiving an alert message, alert generator 162 sends a control packet including the offending signature to an external machine for further analysis.

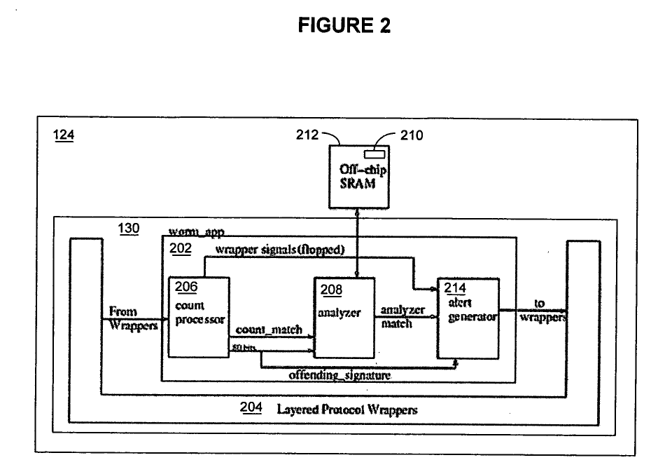

FIG. 2 is a block diagram that shows signature detection device 124 in more detail. In the illustrative example, circuitry for detecting signals over the network is implemented in the field programmable gate array 130 as an application called worm_app 202. Worm_app 202 fits within a framework of layered protocol wrappers 204. As will be described in more detail below, a count processor 206 receives wrapper signals from layered protocol wrappers 204, parses the wrapper signals into a byte stream, hashes the byte stream to a count vector, and increments counters. Count processor 206 further performs count averaging of the number of worm signatures detected and processes benign strings. Count processor 206 outputs a signal count_match that is asserted high for signatures that exceed a threshold as well as a corresponding 10 byte long offending_signature of the worm. In addition, count processor 206 can output signals to layered protocol wrappers 204.

The worm_app circuitry is implemented such that it provides high throughput and low latency. To achieve performance, the worm_app circuitry can have a pipeline. In the illustrative example, the length of the pipeline is 27 clock cycles and can be broken up as follows:
FIFO delays: 3 clock cycles
count processor delay: 11 clock cycles
analyzer delay: 13 clock cycles

An analyzer 208 receives input signals from count processor 206 and interfaces with a hash table 210 stored in an off-chip memory 212, such as a static random access memory (SRAM). Off-chip memory 212 is accessed by analyzer 208 if count_match is asserted high. If the offending_signature is identified in hash table 210 of the off-chip memory 212, then analyzer 208 outputs a signal analyzer_match, which is asserted high. An alert generator 214 receives the analyzer_match signal from analyzer 208 and passes the wrapper signals it receives from count processor 206 to layered protocol wrappers 204. When the analyzer_match signal is asserted high, alert generator 214 sends out a control packet containing the offending_signature.

A component level view of the illustrative count processor 206 is shown in FIG. 3. Count processor 206 comprises a packet buffer 302. As will be described below, packet buffer 302 buffers packets during periods of count averaging, when block RAMs are occupied and counters within the block RAMs cannot be incremented. Aside from periods of count averaging, packet buffer 302 passes through traffic. A character filter 304 decides which bytes to include in the worm signature. A byte shifter 306 uses outputs from character filter 304 to assemble an input string that can be counted. A large count vector 308 hashes the string received from byte shifter 306, incrementing corresponding counters and generating alerts as needed. Each of the functional components of count processor will be described in more detail below.

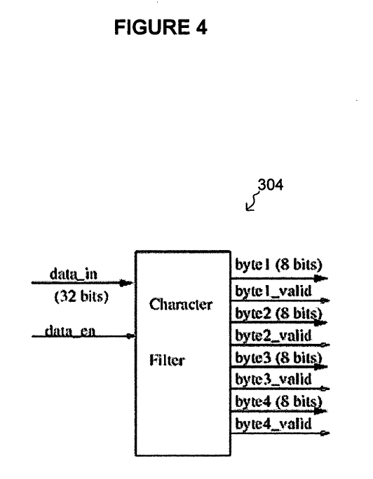

Character filter 304 is shown in more detail in the block diagram of FIG. 4. Character filter 304 allows selected characters to be excluded from the hash computation. Since worms typically consist of binary data, the signature detection device can ignore some characters in the data stream that are highly unlikely to be a part of binary data. These characters include, for example, nulls, line breaks, new lines and whitespace in data streams. Text documents, for example, contain a significant amount of whitespace and nulls for padding. Another reason to be avoiding these characters is that strings of nulls or whitespace do not necessarily characterize a good signature that can be used to identify a worm. It is preferable to use strings that would not appear in documents. Methods and systems consistent with the present invention are not limited to this heuristic approach of avoiding bad signatures. Other approaches that may be implemented include, but are not limited to, identifying and ignoring text in e-mail messages, pre-processing of entire strings, or stream editing to search for regular expressions and replace them with strings.

Character filter 304 receives as input a 32-bit data word data_in as well as a signal data_en, which identifies whether the data in data_in is valid. Character filter 304 splits the 32 bit word into 4 individual bytes (byte1 through byte4) and outputs corresponding signals to indicate if the byte contains valid data (byte1 valid through byte4 valid). A byte is considered invalid if it is one of the characters that character filter 304 is looking for. If for example, the 4-byte string a, newline, b, null is received as input by character filter 304, and given that character filter 304 is configured to ignore newline and null characters, character filter 304's corresponding output signals would be:
Byte1: a, Byte1 valid: High
Byte2: newline, Byte2 valid: Low
Byte3: b, Byte3 valid: High
Byte4: null, Byte4 valid: Low

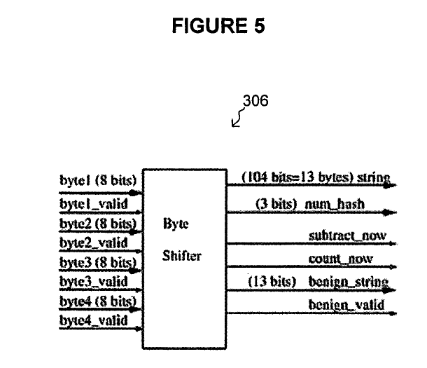

FIG. 5 is a block diagram of the illustrative byte shifter 306. Byte shifter 306 reads in values from character filter 304 and outputs a byte-shifted version of the signature that will be hashed by large count vector 308. Byte shifter 306 also outputs the number of bytes that need to be hashed (num_hash) as well as a signal that tells large count vector 308 when to begin count averaging. Byte shifter 306 accepts data from the outputs of character filter 304. In the illustrative example, the output signature is 13 bytes long and contains 4 overlapping strings of 10 bytes each.

The following illustrative example demonstrates the functionality of the byte shifter. If the input is “NIMDAADMIN123” followed by the string a, newline, b, null from the previous example, then the byte shifted version of the string would be “MDAADMIN123ab” and num_hash would be 2. The value of num_hash will be used by large count vector 308 as described below.

To maintain a running average of the number of signatures detected, counts of detected signatures are periodically reduced. In the illustrative example, this happens at a packet boundary after a fixed number of bytes, such as 2.5 megabytes, have been processed. Byte shifter 306 keeps track of the number of bytes that have been hashed to large count vector 308. When the total bytes processed exceeds a threshold, it then byte shifter 306 goes through the following steps:

1. Byte shifter 308 waits for the last word of the current packet to be read from packet buffer 302 and then stops reading from packet buffer 302. From then on, traffic that comes into count processor 206 is temporarily buffered in packet buffer 302. This is done since the bytes cannot be hashed and counted while count averaging is in progress.

2. When the last word of the current packet has been processed by large count vector 308, byte shifter 306 asserts the subtract_now signal high. This signal is used by large count vector 308 to start count averaging.

Byte shifter 306 asserts the count_now signal high when a start of payload signal from the wrappers is asserted high. Count_now is asserted low when an end of frame signal from the wrappers is asserted high. Accordingly, the bytes comprising the payload alone can be counted.

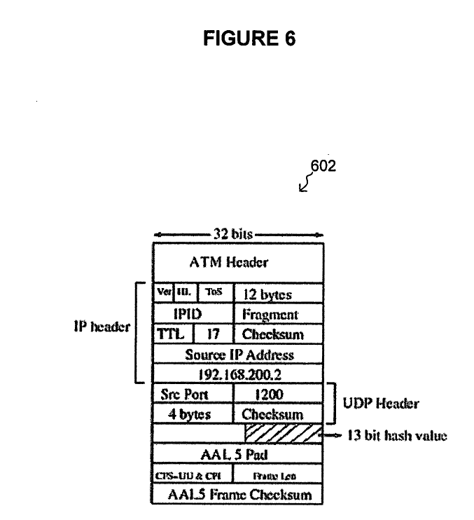

Byte shifter 306 can also determine whether a benign string is present in the data stream. Benign strings, such as a piece of code from a Microsoft Update, can be recognized by programming them into byte shifter 306 as a set of strings, which though commonly occurring on the network, are not worms. Benign strings are loaded into large count vector 308 by receiving a benign string packet at the byte shifter 306 via the data stream. For example, when a packet is sent to the destination address 192.168.200.2 on port 1200, byte shifter 306 assumes the packet contains the 13 bit hash value of a benign string. The top 5 bits of the hash value are used to reference one of 32 block RAMs and the bottom 8 bits are used to refer to one of 256 counters within each block RAM. A diagram of an illustrative control packet 602 containing a benign string is shown in FIG. 6. The bottom 13 bits of the 1st word of the payload is output on benign_string and benign_valid is asserted high. Count_now is asserted low since a control packet containing a benign string need not be counted. The benign_valid and count_string signals are used by large count vector 308 to avoid counting benign strings, as explained below.

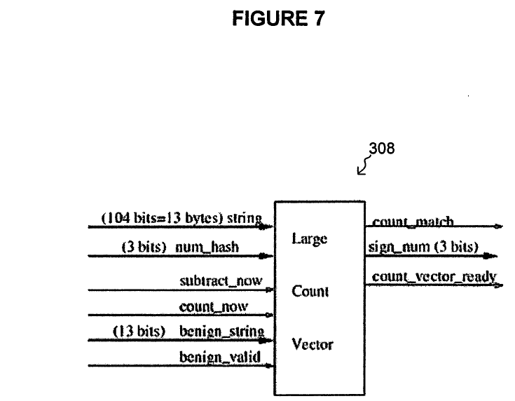

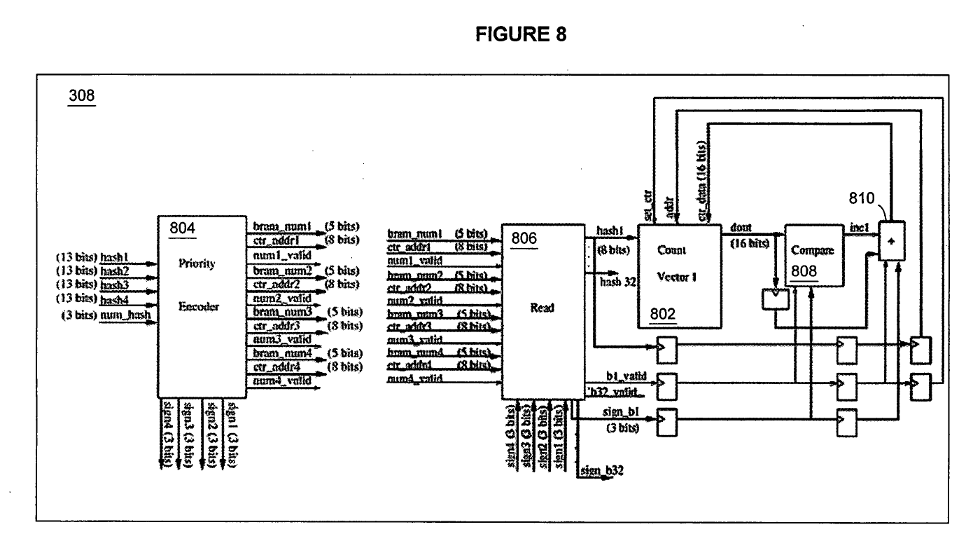

FIG. 7 is a block diagram of the illustrative large count vector 308. The outputs of byte shifter 306 are inputs to large count vector 308. Large count vector 308 contains logic for hashing an incoming string, resolving collisions between block RAMs, reading from block RAM, incrementing counters, and writing back to block RAMs. In the illustrative example, large count vector 308 includes 32 block RAMs, each with 256 counters that are each 16 bits wide. With illustrative counters of this size, it is possible to support counts as large as 64K. The functional components of large count vector 308 are described in more detail below with reference to FIG. 8.

The illustrative large count vector 308 calculates four hash values every clock cycle on the four 10-byte strings that are included in the 13-byte signal string. More than one hash value is computed every clock cycle to maintain throughput. The same hash function is used in each case since the signatures that are tracked may appear at arbitrary points in the payload and they are hashed to the same location regardless of their offset in the packet. Each hash function generates a 13-bit value.

To detect commonly occurring content, large count vector 308 calculates a k-bit hash over a 10 byte (80 bit) window of streaming data. In order to compute the hash, a set k×80 random binary values is generated at the time the count processor is configured. Each bit of the hash is computed as the exclusive or (XOR) over the randomly chosen subset of the 80-bit input string. By randomizing the hash function, adversaries cannot determine a pattern of bytes that would cause excessive hash collisions. Multiple hash computations over each payload ensures that simple polymorphic measures are thwarted. In the illustrative embodiment, a universal hash functions called H₃ is used. The hash function H3 is defined as:
h(X)=d₁·x₁⊕d₂·x₂⊕d₃·x₃⊕ . . . ⊕d_{b}·x_{b}

In the above equation, b is the length of the string measured in bits. In the illustrative example, b=80 bits. (d₁, d₂, d₃, . . . d_{b}) is the set of k×80 random binary values. The random binary values are in the range [0 . . . 2^{m+n-1}](where n is the size of the individual counters in bits and 2^{m} is the number of block RAMs used). In other words, the values of d have the same range as the values of the hash that will be generated. The XOR function performed over the set of random values against the input produces a hash value with a distribution over the input values.

To compute the hash, for each bit in a character string, if that bit is equal to ‘1’ then the random value associated with that bit is XOR-ed with the current result in order to obtain the hash value. For example, given d=(101; 100; 110; 011) and the input string X=1010, the corresponding 3-bit hash function is 101 XOR 110=011.

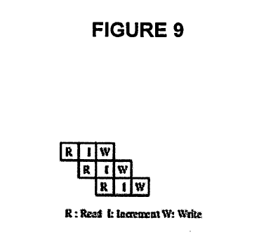

Large count vector 308 uses the hash value to index into a vector of counters, which are contained in count vectors, such as count vector 802. When a signature hashes to a counter, it results in the counter being incremented by one. At periodic intervals, which are referred to herein as measurement intervals, the counts in each of the count vectors are decremented by an amount equal to or greater than the average number of arrivals due to normal traffic. When a counter reaches a pre-determined threshold, analyzer 208 accesses off-chip memory 212, as will be described below, and the counter is reset. For the illustrative implementation of the circuit on a Xilinx FPGA, the count vector is implemented by configuring dual-ported, on-chip block RAMs as an array of memory locations. Each of the illustrative memories can perform one read operation and one write operation every clock cycle. A three-stage pipeline is implemented to read, increment and write memory every clock cycle as shown in FIG. 9. Since the signature changes every clock cycle and since every occurrence of every signature is counted, high performance is needed from the memory subsystem. Dual-ported memories allow the write back of the number of occurrences of one signature while another is being read.

To mark the end of a measurement interval, large count vector 308 can reset the counters periodically. After a fixed window of bytes pass through, all of the counters are reset by writing the values to zero. However, this approach has a shortcoming. If the value of a counter corresponding to a malicious signature is just below the threshold at the time near the end of the measurement interval, then resetting this counter will result in the signature going undetected. Therefore, as an alternative, the illustrative large count vector 308 periodically subtracts an average value from all the counters. The average value is computed as the expected number of bytes that would hash to each counter in the interval. This approach requires the use of comparators and subtractors as described below.

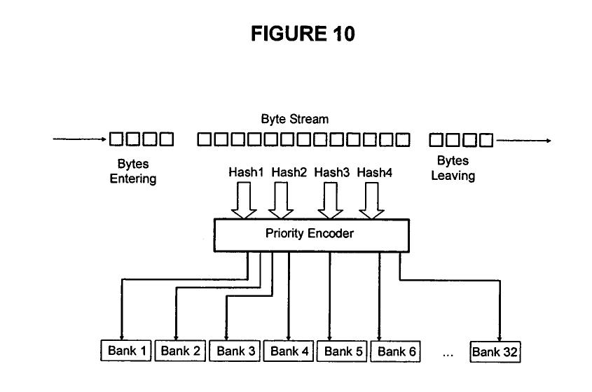

To achieve a high throughput, multiple strings can be processed in each clock cycle. To allow multiple memory operations to be performed in parallel, the count vectors are segmented into multiple banks using multiple block RAMs in content detection system 130 as shown in FIG. 10. The higher order bits of the hash value are used to determine which block RAM to access. The lower bits are used to determine which counter to increment within a given block RAM. It is possible that more than one string could hash to the same block RAM. This situation is referred to as a “bank collision” herein. A bank collision can be resolved using a priority encoder. Due to the operation of priority encoder, between 1 and 3 strings may not be counted every clock cycle for a system that runs at OC-48 line rates.

The probability of collision, c, is given by the following equation:

$$c = 1 - {\prod }_{i = N - B + 1}^{N - 1} \frac{i}{N}$$

In the equation above, N is the number of block RAMs used and B is the number of bytes coming per clock cycle.

A priority encoder, such as priority encoder 804, resolves collisions that can occur when the upper 5 bits of two or more of the four hash values is the same. Priority encoder 804 outputs the addresses of the block RAMs that need to be incremented. As shown in FIG. 8, the upper 5 bits of the hash value is used to identify the block RAM that is to be incremented. The lower 8 bits are used to index to the counter within the block RAM that is to be incremented. Bram_numl through bram_num4 refer to the block RAMs. Ctr_addr1 through ctr_addr4 refer to the counter number within each block RAM that is to be incremented. Num1_valid through num4_valid are asserted high when the corresponding block RAM and counter addresses are valid. Since the alerts can be generated by any one of 32 block RAMS and there are four possible signatures that the alert could correspond to, large count vector 308 tracks which signature triggered the alert. This is accomplished by using signals sign1 through sign4 that correspond to the bram_num and ctr_addr signals. In the illustrative example, the signals sign1 through sign4 can have one of five values: one, two, three and four correspond to the first, second, third and fourth signature in the 13-byte signal string. A value of eight represents a benign string.

The value of num_hash determines the number of block RAMs among which collisions need to be resolved. If, for example, the value of this signal is two, it means that byte shifter 306 has shifted the signature by two bytes. Consequentially, only two signatures are counted since the other two have already been counted.

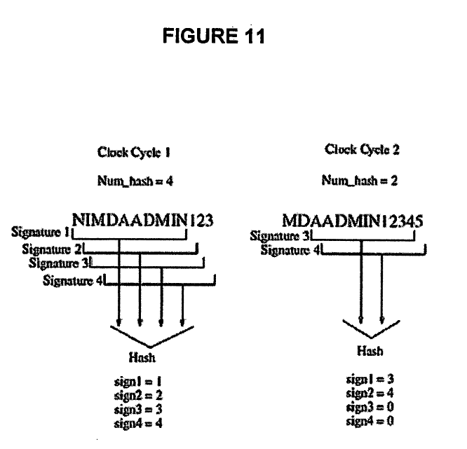

An illustrative example of the functionality of the priority encoder in the absence of collisions is shown in FIG. 11. In the illustrative example, in the first clock cycle, all four incoming bytes are deemed valid by the character filter. Therefore, all four signatures are hashed, and sign1 through sign4 have valid values along with their corresponding bram_num and ctr_addr signals. In the second clock cycle, only two of the four incoming bytes are deemed valid by the character filter. Therefore, only two signatures are hashed. Therefore only sign1 and sign2 have valid values referring to signatures 3 and 4.

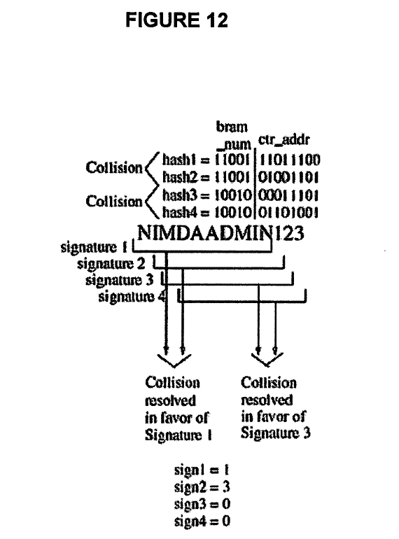

An illustrative example of the functionality of the priority encoder in the presence of collisions is shown in FIG. 12. As shown in the illustrative example, the block RAMs that are incremented collide in two cases. In both cases, the collision is resolved in favor of one of the signatures. The priority of one signature over another is in large count vector 308.

In the illustrative embodiment, since the inherent functionality of the block RAM does not include support for resetting and count averaging, a wrapper is provided around the block RAM to effect that functionality. The functionality of the wrapper is illustratively represented by the illustrative count vector shown by in FIG. 8. Thirty-two copies of this count vector component are instantiated in large count vector 308—one for each block RAM that is being used.

As shown in the illustrative example of the count vector, the count vector has a reset signal. When reset signal is asserted low, each of the counters is initialized to 0. Since the block RAMs are initialized in parallel, in the illustrative example, this takes 256 clock cycles (the number of counters in each Block RAM). Hash identifies the address in the count_vector that is to be read. Dout identifies the data in the counter corresponding to hash. Addr identifies the address to which the incremented count is written back, which will be described below. Ctr_data identifies the value that is to be written back to the count vector. Set_ctr provides a write enable for the count_vector. When subtract is asserted high, the large count vector iterates through each of the counters and subtracts the value of the average from it. As mentioned previously, the average is computed as the expected number of bytes that would hash to the counter in each interval. If the value of a given counter is less than the average then it is initialized to zero. If the value of a given counter contains the special field associated with benign strings, it is not subtracted. As with initializing the count vector, parallelism ensures that the subtraction is accomplished in 256 clock cycles.

To support benign strings, a counter corresponding to the hash of a benign string is populated with a value beyond the threshold. When a counter has this value, the circuit skips the increment and write back steps.

For a limited number of common strings, it is possible to not count hash buckets, and thus to avoid sending alerts. But as the number of benign strings approaches the number of counters available, the effectiveness is reduced because there are fewer counters that are used to detect signatures. For a larger number of less commonly-occurring strings, it is possible to avoid false positive generation in downstream software. To reduce false positives sent to the downstream software, strings that are benign but do not occur very frequently can be handled by a control host.

Referring back to FIG. 8, the inputs to a read stage 806 are the outputs from priority encoder 804. The outputs from read stage 806 are connected to the address and data buses of the 32 block RAMs (e.g., to count vector 802). However, only one count vector 802 is shown in FIG. 8 for simplicity. The appropriate address and data signals are asserted depending on the value of the bram_num input to read stage 806. The signals sign1 through sign4 that enter read stage 806 are assigned to any of sign b1 through sign b32 (henceforth referred to as the “sign” signal while referring to any one block RAM) that leave read stage 806 except while handling control packets containing benign strings. In that case, the output sign signal is assigned a value of 8 so that a compare component 808 and an increment component 810 can handle it appropriately.

The output of the count vector, such as count vector 802, is examined by its respective compare component 808 and if it is less than the threshold, then the compare component's inc signal is asserted high. If it is equal to threshold, then large count vector 308 sets the count_match signal high to inform analyzer 208 about a potential frequently occurring signature. The count_match signal results in off-chip memory 212 being occupied for 13 clock cycles (since this is the time taken to read a 10 byte string from off-chip memory 212, compare a string, and write back that string), a count_match suppress signal ensures that there is a gap of at least 13 clock cycles between two count_match signals.

In an increment and write-back stage, there are four illustrative functions that the increment and write back stage in the pipeline can perform. In each case, ctr_data is the value that is written back to the count vector. The four illustrative functions are as follows:
If the inc signal has been asserted high, then the value of ctr_data is set to one more than the output of count_vector.
If the value of sign is 8, then the value associated with benign strings is assigned to ctr_data. In the illustrative example, this value is 0xFFFF.
If the output of the count vector is 0xFFFF, then the same value is assigned to ctr_data in order to preserve benign strings.
The default value of ctr_data is 0. This is not changed if the counter has exceeded the threshold.

The valid signal (e.g., b1_valid), when flopped an appropriate number of times, is used as an input to the write enable of the count vector (i.e., set_ctr).

During placing and routing, some of the block RAMs may be placed in such a manner that large propagation delays may be incurred. This may result in the circuit not meeting timing constraints. This situation is remedied in the illustrative example by including flip-flops to the inputs and outputs to the block RAMs. The additional flip-flips are not shown in FIG. 8 to preserve simplicity.

When an offending signature is found, large count vector 308 outputs count_match along with the corresponding signature (sign_num). Count processor 206 flops string an appropriate number of times to reflect the latency of large count vector 308. When count_match is asserted high, the offending_signature is chosen based on the value of sign_num.

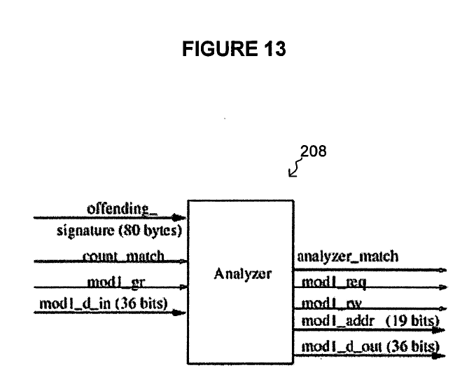

FIG. 13 is a block diagram of an illustrative analyzer 208. Analyzer 208 holds suspicious signatures and estimates how often a certain signature has occurred. Thus, analyzer 208 can reduce the number of alerts sent by alert generator 214. To do so, the analyzer makes sure that counters going over the threshold are indeed the result of a frequently occurring strings. When a counter crosses the threshold, the offending string is hashed to a table in off-chip memory 212. A 17-bit hash value is calculated on the offending signature using the method described above. The off-chip memory 212 data bus is 19 bits wide. The hash value maps to the top 17 bits of the address signal. The bottom two bits of the address signal are varied to represent three consecutive words in memory (which is used to store a 10 byte string). The hash value is used to index into the off-chip memory hash table 210. The next time the same string occurs, analyzer 208 hashes to the same location in off-chip memory 212 and compares the two strings. If the two strings are the same, an alert is generated. If the two strings are different, analyzer 208 performs an overwrite of off-chip memory 212 location and stores the other string. In that case, it is likely that the counter overflow occurred because the hash function hashed several semi-frequently occurring strings to the same value. Since semi-frequently occurring strings are not of interest, analyzer 208 prevents the occurrence of the overhead of generating an alert packet.

The illustrative signals of analyzer 208 are explained below:

count_match: When asserted high by large count vector 308, a signature has caused a counter to reach threshold.

offending_signature: The signature that corresponds to a count_match being asserted high.

analyzer_match: When asserted high, the analyzer has verified that the counter reaching the threshold was not the result of a false positive.

mod1_req: When asserted high, this signal indicates a request to access off-chip memory 212. It is held high for the duration of time during which off-chip memory 212 is being accessed.

mod1_gr: When asserted high, this signal indicates permission to access off-chip memory 212.

mod1_rw: Analyzer 208 reads from off-chip memory 212 when this signal is asserted high and writes to off-chip memory 212 when asserted low.

mod1_addr: Indicates the off-chip memory address to read from or write to.

mod1_d_in: Includes data being read from off-chip memory 212.

mod1_d_out: Includes data being written to off-chip memory 212.

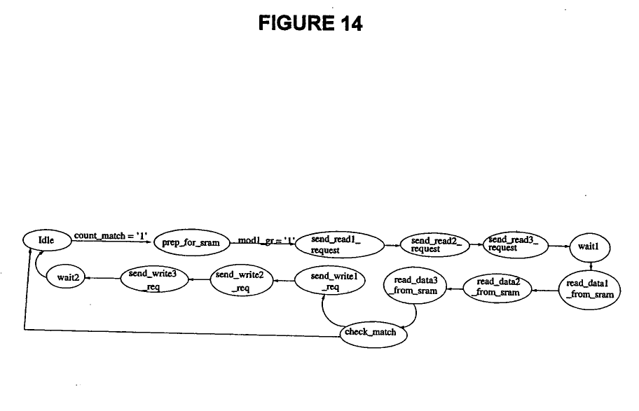

Analyzer 208 is configured to include a number of finite states for off-chip memory 212 access. An illustrative finite state machine for analyzer 208 is shown in FIG. 14. Each of the illustrative states depicted in FIG. 14 is explained below.

idle: Is the default state for analyzer 208. Analyzer 208 transitions out of this state when count_match is asserted high.

prep_for_sram: Permission to access off-chip memory 212 is requested in this state. Analyzer 208 transitions out of this state when permission is granted.

send_read_request: As shown in the illustrative example of FIG. 14, three send_read_request states are effected. In all three states that send read requests, mod1_rw is asserted high and mod1_addr is set to values derived from the hash of the offending_signature.

wait1: Wait for data to be read from off-chip memory 212.

read_data_from_sram: The data that comes from off-chip memory 212 on mod1_d_in is read into temporary registers.

check_match: The temporary registers are concatenated and compared with offending_signature. If the two are equal then analyzer_match is asserted high and analyzer 208 transitions back to idle. If the two are not equal, analyzer 208 writes the new string back to memory.

send_write_request: mod1_rw is asserted low and, as with the read states, mod1_addr is set to values derived from the hash of the offending_signature.

Once mod1_gr goes high, each of transitions in analyzer 208 takes place on the edge of the clock.

Off-chip memory 212 is used to store the full string (unhashed version), which is 10 bytes (80 bits) long in the illustrative example. Analyzer 208, though hundreds of times faster than software, still requires a few additional clock cycles to access off-chip memory 212, which could stall a data processing pipeline. In the illustrative example, access to the 10-byte string in off-chip memory 212 requires 13 clock cycles.

It would be possible to implement a circuit that stalls the data processing pipeline every time a memory read is performed from off-chip memory 212. However, stalling the pipeline has a disadvantage. The purpose of calculating hash values over a window of bytes as opposed to the whole packet payload is to handle the case of polymorphic worms. But consider the more common case of non-polymorphic worms wherein the packet payloads of the worm traffic are more or less identical. In that case, methods and systems consistent with the present invention can generate a series of continuous matches over the entire packet payload. Stalling the pipeline for each match may then result in severe throughput degradation since it takes multiple clock cycles for each off-chip memory 212 access. Indeed, doing so may be beneficial to the attacker, since a system administrator may be forced to turn off the system. In the illustrative example, the solution is to not to stall the pipeline while reading from off-chip memory 212, but rather to skip further memory operations until previous operations are completed. Therefore, once an alert is generated, data over the next 13 clock cycles (the latency involved in reading and writing back to off-chip memory 212) does not result in further alerts being generated.

Within a measurement interval, the number of signatures observed can be approximately equal to the number of characters processed. It can be less because a small fraction of the characters are skipped due to bank RAM collisions. The problem of determining threshold, given a length of measurement interval can be reduced to determining the bound on the probability that the number of elements hashing to the same bucket exceeds i when m elements are hashed to a table with b buckets. The bound is given by:

$$b {( \frac{em}{ib} )}^{i}$$

In the illustrative example, m signatures are hashed to b counters. In the above expression, i is the threshold. Hence, given a length of measurement interval, the threshold can be varied to make the upper bound on the probability of a counter exceeding the threshold acceptably small. This in turn reduces the number of unnecessary off-chip memory 212 accesses. Therefore, since incoming signatures hash randomly to the counters, anomalous signatures are likely to cause counters to exceed the threshold for appropriately large thresholds.

The probability that a counter receives exactly i elements can be given by:

$$( \begin{matrix}m \\ i\end{matrix} ) {( \frac{1}{b} )}^{i} {( 1 - \frac{1}{b} )}^{( m - i )} \leq ( \begin{matrix}m \\ i\end{matrix} ) {( \frac{1}{b} )}^{i} \leq ( \frac{me}{i} ) {( \frac{1}{b} )}^{i} = {( \frac{me}{bi} )}^{i}$$

The second inequality is the result of an upper bound on binomial coefficients. The probability that the value of a counter is at least i can be given by:

$$Pr ( c \geq i ) \leq {\sum }_{k = i}^{m} {( \frac{em}{bk} )}^{k} \leq {( \frac{em}{ib} )}^{i} [ 1 + ( \frac{em}{ib} ) + {( \frac{em}{ib} )}^{2} + ⋯ + {( \frac{em}{ib} )}^{( m - i )} ]$$

As i increases, the term inside the square brackets approximates to 1. Therefore, the probability that the value of a counter is at least i is bounded by:

$$b {( \frac{em}{ib} )}^{i}$$

In the illustrative embodiment, since the measurement interval m is 2.5 MBytes, the number of counters b is 8192, and threshold i is 850, the bound on the probability of counter overflow for random traffic is 1.02×10⁻⁹. Accordingly, the probability of counter overflow can be as small as desired for the amount of traffic processed within the interval.

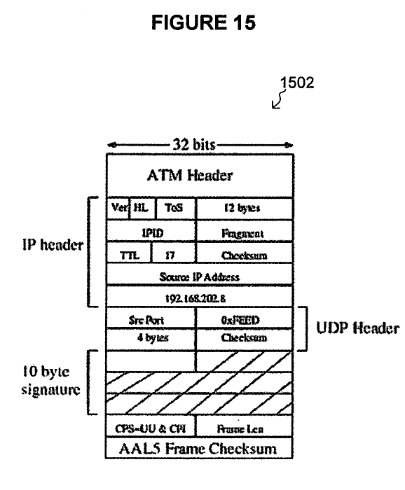

On receiving an alert message from the analyzer 208, alert generator 214 sends a user datagram protocol (UDP) control packet to an external data processing system that is listening on a known UDP/IP port. The packet can contain the offending signature (the string of bytes over which the hash was computed). When analyzer_match is asserted high, alert generator 214 sends out the control packet. Accordingly, the most frequently occurring strings can then be flagged as being suspicious. FIG. 15 is a block diagram of an illustrative control packet 1502 issued from alert generator 214.

Therefore, methods and systems consistent with the present invention detect frequently occurring signatures in network traffic. By implementing the content detection in hardware, high throughputs can be achieved. Further, by exploiting the parallelism afforded by hardware, a larger amount of traffic can be scanned compared to typical software-based approaches. Throughput is maintained by hashing several windows of bytes in parallel to on chip block memories, each of which can be updated in parallel. This is unlike traditional software-based approaches, wherein the hash followed by a counter update would require several instructions to be executed sequentially. Further, the use of an off-chip memory analyzer provides a low false positive rate. Also, taking multiple hashes over each packet helps the system thwart simple polymorphic measures.

Previous network monitoring tools relied on the system administrator's intuition to detect anomalies in network traffic. Methods and systems consistent with the present invention automatically detect that a spike in network traffic corresponds to frequently occurring content.

The foregoing description of an implementation of the invention has been presented for purposes of illustration and description. It is not exhaustive and does not limit the invention to the precise form disclosed. Modifications and variations are possible in light of the above teachings or may be acquired from practicing the invention. For example, the described implementation includes software but the present implementation may be implemented as a combination of hardware and software or hardware alone. Further, the illustrative processing steps performed by the program can be executed in an different order than described above, and additional processing steps can be incorporated. The scope of the invention is defined by the claims and their equivalents.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed is:

1. A method in a data processing system for identifying a repeating content in a data stream, the method comprising the steps of:
computing a hash function for at least one portion of a plurality of portions of the data stream;
incrementing at least one counter of a plurality of counters responsive to the computed hash function result, each counter corresponding to a respective computed hash function result;
identifying the repeating content when the at least one of the plurality of counters exceeds a count value; and
verifying that the identified repeating content is not a benign string.

2. The method of claim 1, wherein computing the hash function comprises computing a plurality of hash functions in parallel for a plurality of portions of the data stream.

3. The method of claim 2, wherein the plurality of counters are located in a plurality of memory banks.

4. The method of claim 3, further comprising the step of:
determining a priority of which counter to increment when a plurality of counters located in a same memory bank are to be incremented in a same clock cycle.

5. The method of claim 1, further comprising the step of:
filtering the at least one portion of the plurality of portions of the data stream to remove predetermined data.

6. The method of claim 1, further comprising the step of:
periodically decrementing each of the plurality of counters using count averaging.

7. The method of claim 1, further comprising the step of:
determining whether the identified repeating content is a false identification.

8. The method of claim 7, wherein the determination of whether the identified repeating content is a false identification is performed by comparing the identified repeating content to previously-identified repeating content.

9. The method of claim 8, wherein the previously-identified repeating content is stored in a memory remote from a local memory that includes the identified repeating content.

10. The method of claim 1, wherein a pipeline is used to increment the at least one of the plurality of counters.

11. The method of claim 1, wherein the repeating content is a worm signature.

12. The method of claim 1, wherein the identified repeating content has a non-pre-defined signature.

13. The method of claim 1, wherein the repeating content is a virus signature.

14. The method of claim 1, wherein the repeating content is a spam signature.

15. The method of claim 1, wherein the repeating content is a repeated exchange of content over a network.

16. The method of claim 1, wherein the repeating content is an occurrence of a number of users visiting a website.

17. A system for identifying a repeating content in a data stream, the system comprising:
a hash function computation circuit that computes a hash function for the least one portion of the plurality of portions of the data stream;
a plurality of counters, at least one counter of a plurality of counters being incremented responsive to the computed hash function result, each counter corresponding to a respective computed hash function result;
a repeating content identifier that identifies the repeating content when the at least one of the plurality of counters exceeds a count value; and
a verifier that verifies that the identified repeating content is not a benign string.

18. The system of claim 17, wherein computing the hash function comprises computing a plurality of hash functions in parallel for a plurality of portions of the data stream.

19. The system of claim 18, wherein the plurality of counters are located in a plurality of memory banks.

20. The system of claim 19, comprising:
a priority encoder that determines a priority of which counter to increment when a plurality of counters located in a same memory bank are to be incremented in a same clock cycle.

21. The system of claim 17, comprising:
a filter that filters the at least one portion of the plurality of portions of the data stream to remove predetermined data.

22. The system of claim 17, wherein each of the plurality of counters are periodically decremented using count averaging.

23. The system of claim 17, comprising:
an analyzer that determines whether the identified repeating content is a false identification.

24. The system of claim 23, wherein the determination of whether the identified repeating content is a false identification is performed by comparing the identified repeating content to previously-identified repeating content.

25. The system of claim 24, wherein the previously-identified repeating content is stored in a memory remote from a local memory that includes the identified repeating content.

26. The system of claim 17, wherein a pipeline is used to increment the at least one of the plurality of counters.

27. The system of claim 17, wherein the repeating content is a worm signature.

28. The system of claim 17, wherein the identified repeating content has a non-pre-defined signature.

29. The system of claim 17, wherein the repeating content is a virus signature.

30. The system of claim 17 wherein the repeating content is a spam signature.

31. The system of claim 17 wherein the repeating content is a repeated exchange of content over a network.

32. The system of claim 17, wherein the repeating content is an occurrence of a number of users visiting a website.

33. A system for identifying a repeating content in a data stream, the system comprising:
means for computing a hash function for at least one portion of a plurality of portions of the data stream, the at least one portion of the data stream having benign characters removed therefrom to prevent the identification of a benign string as the repeating content;
means for incrementing at least one counter of a plurality of counters responsive to the computed hash function result, each counter corresponding to a respective computed hash function result;
means for identifying the repeating content when the at least one of the plurality of counters exceeds a count value; and
means for verifying that the identified repeating content is not a benign string.
